(19) United States
(12) Patent Application Publication
(10) Pub. No.: US 2025/0058762 A1
(43) Pub. Date: Feb. 20, 2025

(54) VIRTUAL GEAR SHIFT CONTROL APPARATUS AND METHOD FOR AN ELECTRIC VEHICLE

(71) Applicants: HYUNDAI MOTOR COMPANY, Seoul (KR); KIA CORPORATION, Seoul (KR)

(72) Inventors: Joseph D. Chang, Suwon-si (KR); Soo Han Song, Seoul (KR); Seong Hwan Cheong, Suwon-si (KR); Sung Hyun Cho, Yongin-si (KR)

(73) Assignees: HYUNDAI MOTOR COMPANY, Seoul (KR); KIA CORPORATION, Seoul (KR)

(21) Appl. No.: 18/771,251

(22) Filed: Jul. 12, 2024

(30) Foreign Application Priority Data
Aug. 14, 2023 (KR) 10-2023-0106064
Dec. 7, 2023 (KR) 10-2023-0176469

(51) Int. Cl. B60W 10/08; B60W 30/19

(52) U.S. Cl. CPC B60W 10/08; B60W 30/19; B60W 2510/0638; B60W 2710/083

(57) ABSTRACT

A virtual gear shift control apparatus for an electric vehicle is disclosed. The apparatus includes a driving information detector that detect information indicating a vehicle driving state. The apparatus also includes a controller that generates a motor torque command for satisfying a driver's demand torque based on the vehicle driving information including the information detected by the driving information detector. The controller determines whether the vehicle driving state of the electric vehicle corresponds to a predetermined power-off condition, determines, in response to a determination that the vehicle driving state corresponds to the predetermined power-off condition, a coasting torque corresponding to a current virtual gear stage and a current virtual engine speed. The controller also generates a motor torque command using the determined coasting torque as a command value. The controller also controls a regenerative operation of a motor that drives the electric vehicle according to the generated motor torque command.

### CROSS-REFERENCE TO RELATED APPLICATION

This application claims under 35 U.S.C. § 119(a) the benefit of priority to Korean Patent Application No. 10-2023-0176469 filed on Dec. 7, 2023, and Korean Provisional Application No. 10-2023-0106064, filed on Aug. 14, 2023, the entire contents of which are incorporated herein by reference.

### BACKGROUND

### (a) Technical Field

The present disclosure relates to a virtual gear shift control apparatus for an electric vehicle and a method thereof, capable of providing a user with a distinct shift feel, a sporty and fast shift feel, and a realistic shift feel during virtual gear shifting.

### (b) Background Art

As is known, an electric vehicle (EV) is a vehicle that runs using a motor. Such electric vehicles include a battery that supplies power for driving a motor and include an inverter connected to the battery. The motor is connected to the battery to be charged and discharged through the inverter and is a drive unit that drives the vehicle. Such electric vehicles also include a gear reducer that reduces the torque of the motor and transmits the torque to driving wheels.

Here, the inverter is provided to drive and control the motor. In driving the motor, the inverter converts a direct current (DC) supplied from the battery into an alternating current (AC) and applies the result to the motor through a power cable. In regenerating the motor, the inverter converts an alternating current (AC) generated from the motor into a direct current (DC) and transmits the result to the battery to charge the battery.

Unlike conventional internal combustion engine vehicles, most electric vehicles have a configuration in which a multi-speed transmission is not used. Instead, a gear reducer having a fixed gear ratio is disposed between the motor and the driving wheels.

This is because, unlike an internal combustion engine (ICE), which has a wide distribution range of energy efficiency according to an operating point and can provide high torque only in a high-speed range, a motor has a relatively small difference in efficiency according to the operating point and has low speed and high torque achieved using characteristics of the motor alone.

In addition, vehicles equipped with a conventional internal combustion engine drive system require an oscillator, such as a torque converter or a clutch, due to the characteristics of the internal combustion engine that cannot be driven at low speed. However, in a drive system of an electric vehicle, because its motor has characteristics of easy driving at low speed, the oscillator is not required.

The drive system of the electric vehicle generates power by driving the motor with power from a battery, rather than generating power by burning fuel in the internal combustion engine vehicle. Accordingly, unlike torque of the internal combustion engine generated by aerodynamic and thermodynamic reactions, torque of the electric vehicle is generally precise, smooth, and responsive compared with the torque of the internal combustion engine.

Due to these mechanical differences, unlike the internal combustion engine vehicle, the electric vehicle can provide smooth driving without interruption due to gear shifting. However, the absence of the transmission in the electric vehicle is advantageous in that the electric vehicle provides smooth driving without interruption due to gear shifting. However, for drivers who want the fun of driving, the absence of mechanical elements such as a transmission and the absence of a shift feel may cause boredom or dissatisfaction with the driving experience.

Accordingly, in an electric vehicle that does not have a multi-speed transmission and is equipped with the gear reducer, there is a demand for a technique that allows a driver to feel driving emotion, fun, excitement, and a direct connection provided by the vehicle equipped with the multi-speed transmission.

In particular, when the driver wants to feel the driving emotion, fun, excitement, and direct connection provided by an engine, transmission, clutch, and the like, it is desirable to provide a function to implement virtual drivability so that the driver can variously experience desired emotions in the same vehicle without replacing the vehicle.

Accordingly, as one of several techniques for realizing the characteristics of an internal combustion engine vehicle in an electric vehicle, a virtual gear shift (VGS) system, which virtually provides the same shift feel as in an internal combustion engine vehicle in the electric vehicle, is known.

In this virtual gear shift control, a virtual engine speed (RPM) and a virtual gear stage are displayed on a cluster. At the same time, virtual engine sound is output through a sound output device. Thus, a virtual gear shift system can provide an experience similar to gear shifting of an internal combustion engine vehicle to the driver.

More specifically, a virtual gear shift system in the electric vehicle may be mainly implemented using three techniques. The first technique is a technique of controlling motor torque in an electric vehicle to generate torque and a virtual shift feel, for each virtual gear stage. The second technique is a technique of displaying a virtual engine speed and a virtual gear stage on an instrument cluster to provide a visual effect to the driver. The third technique is a technique of outputting virtual engine sound through internal and external speakers of the vehicle to provide an auditory effect to the driver.

In this regard, when power-off downshifting in an electric vehicle equipped with a virtual gear shift system, in general, virtual gear shift control has been performed to implement a shift feel by linearly changing motor torque from a constant coasting torque in a gear stage before shifting under a power-off (coasting) condition to a constant coasting torque in a target gear stage (gear stage after shifting).

Further, in the prior art, a virtual gear shift system is configured so that, within the same virtual gear stage, the motor torque is set and implemented as a constant coasting torque determined for each stage regardless of a virtual engine speed or a vehicle speed.

As described above, in a general power-off downshift virtual gear shift control, because the motor torque for the virtual shift feel is controlled by linearly changing from the coasting torque in the gear stage before shifting to the coasting torque in the gear stage after shifting, it is only possible to implement a shift feel that is not sporty and only having a dragging feel, and it is difficult to provide a realistic shift feel.

The above information disclosed in this Background section is only to enhance understanding of the background of the present disclosure. Therefore, the Background section may contain information that does not form the prior art that is already known to a person of ordinary skill in the art.

### SUMMARY OF THE DISCLOSURE

The present disclosure has been made in an effort to solve the above-described problems associated with prior art. Objects of the present disclosure are to provide a virtual gear shift control apparatus for an electric vehicle and a method thereof, capable of providing a user with a distinct shift feel, a sporty and fast shift feel, and a realistic shift feel during virtual gear shifting.

The objects of the present disclosure is not limited thereto. Other objects should be more clearly understood by those having ordinary skill in the art in the technical field to which the present disclosure pertains from the description below.

In one aspect, a method of controlling virtual gear shift for an electric vehicle includes determining, by a controller, whether a vehicle driving state of the electric vehicle corresponds to a predetermined power-off condition. The method also includes determining, by the controller, in response to a determination that the vehicle driving state corresponds to the predetermined power-off condition, a coasting torque corresponding to a current virtual gear stage and a current virtual engine speed. The method also includes generating, by the controller, a motor torque command using the determined coasting torque as a command value. The method also includes controlling, by the controller, a regenerative operation of a motor that drives the electric vehicle according to the generated motor torque command.

In another aspect, a virtual gear shift control apparatus for an electric vehicle includes a driving information detector that detects information indicating a vehicle driving state. The apparatus also includes a controller that generates a motor torque command for satisfying a driver's demand torque based on the vehicle driving information including the information detected by the driving information detector. The controller also determines whether the vehicle driving state of the electric vehicle corresponds to a predetermined power-off condition. The controller also determines, in response to a determination that the vehicle driving state corresponds to the predetermined power-off condition, a coasting torque corresponding to a current virtual gear stage and a current virtual engine speed. The controller also generates a motor torque command using the determined coasting torque as a command value. The controller also controls a regenerative operation of a motor that drives the electric vehicle according to the generated motor torque command.

Here, the predetermined power-off condition may include a condition that a driver's demand torque is equal to or less than a preset reference value.

Further, determining the coasting torque may include determining an engine friction torque corresponding to the current virtual engine speed using setting data with a virtual engine speed as an input. Determining the coasting torque may also include determining the coasting torque as a negative torque value obtained by multiplying the determined engine friction torque by a gear ratio of the current virtual gear stage and a final reduction gear ratio.

Here, the setting data may be a function or a map that defines a relationship between the virtual engine speed and the engine friction torque.

Further, the method may include determining, by the controller, whether there is a downshift request according to the vehicle driving state. The method may further include performing, by the controller, a power-off downshift control process in response to a determination that there is the downshift request and the vehicle driving state corresponds to the predetermined power-off condition. Performing the power-off downshift control process may include, in a process of transitioning from a coasting torque in a gear stage before shifting to a coasting torque in a gear stage after shifting, entering, by the controller, an actual shift section in which the coasting torque increases to a preset neutral torque and then is kept constant.

Here, performing the power-off downshift control process may further include entering, by the controller, a shift preparation section in which the coasting torque corresponding to the virtual gear stage before shifting and the current virtual engine speed that is a real-time speed is determined during a first maintenance time after the power-off downshift control process starts. Performing the power-off downshift control process may further include entering, by the controller, the actual shift section after the shift preparation section ends during the first maintenance time.

Further, when entering the actual shift section, the controller may increase a virtual engine speed at the time of entering the actual shift section with a slope for engine rev-matching control.

In addition, performing the power-off downshift control process may further include entering, by the controller, a shift end-stage engagement control section that increases a virtual engine speed to a synchronous speed in the virtual gear stage after shifting, after the actual shift section ends. Performing the power-off downshift control process may further include simultaneously decreasing, by the controller, the coasting torque from the preset neutral torque to the coasting torque corresponding to the virtual gear stage after shifting.

During the actual shift section, the controller may determine a shift progress from the current virtual engine speed, may terminate, in a case where the shift progress becomes a set value, the actual shift section, and may enter the shift end-stage engagement control section.

Further, the controller may determine the shift progress using an Equation E1:

Shift progress (%)={(current virtual engine speed−first speed)/(third speed−first speed)}×100, wherein the first speed is a virtual engine speed at the time of entering the actual shift section, the third speed is the synchronous speed of the virtual gear stage after shifting and is a virtual engine speed corresponding to a current vehicle speed and the virtual gear stage after shifting, and the current virtual engine speed is a real-time speed.

In addition, performing the power-off downshift control process may further include entering, by the controller, a shift end section in which the coasting torque corresponding to the virtual gear stage after shifting and the current virtual engine speed that is a real-time speed is determined, during a second maintenance time after the shift end-stage engagement control section ends.

Further, the current virtual engine speed may be determined as a value proportional to a value obtained by multiplying the current vehicle speed by a virtual gear ratio corresponding to the current virtual gear shift stage, by the controller.

Other aspects and embodiments of the present disclosure are discussed below.

It should be understood that the term “vehicle” or other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, vehicles powered by both electricity and gasoline.

The above and other features of the present disclosure are discussed below.

### BRIEF DESCRIPTION OF THE DRAWINGS

The above and other features of the present disclosure are described in detail with reference to certain embodiments thereof illustrated the accompanying drawings, which are given hereinafter by way of illustration only and thus do not limit the present disclosure, and wherein:

FIG. 1 is a block diagram showing a configuration of an apparatus that performs a virtual gear shift control process according to an embodiment of the present disclosure;

FIG. 2 is a diagram showing a drive system model of an internal combustion engine vehicle to which the present disclosure is applicable;

FIG. 3 is a diagram illustrating a neutral feel in a REV-matching section of an internal combustion engine vehicle;

FIG. 4 is a diagram showing a vehicle deceleration state according to gear stages and vehicle speeds during power-off downshift for comparison with the present disclosure;

FIG. 5 is a diagram showing a vehicle deceleration state according to gear stages and vehicle speeds during power-off downshift by the virtual gear shift control according to the present disclosure;

FIG. 6 is a flowchart showing a virtual gear shift control process according to an embodiment of the present disclosure;

FIG. 7 is a diagram showing a control state by a virtual gear shift control method according to an embodiment of the present disclosure; and

FIG. 8 is a diagram showing a control state by a conventional virtual gear shift control method for comparison with the present disclosure.

It should be understood that the appended drawings are not necessarily drawn to scale, presenting a somewhat simplified representation of various features, which illustrate the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

Hereinafter, reference is made in detail to various embodiments of the present disclosure, examples of which are illustrated in the accompanying drawings and described below. While the present disclosure is described in conjunction with various embodiments, it should be understood that the present description is not intended to be limited to the embodiments. On the contrary, the present disclosure is intended to cover not only the embodiments described herein, but also various alternatives, modifications, equivalents, and other embodiments, which may be included within the spirit and scope of the present disclosure as defined by the appended claims.

It should be understood that, although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the embodiments of the present disclosure.

In addition, it should be understood that, when an element is “connected” or “coupled” to another element, the element may be directly connected or coupled to the other element or may be indirectly connected or coupled to the other element with a different element being interposed therebetween. In contrast, when an element is “directly connected” or “directly coupled” to another element, it means that there is no intervening element therebetween. Other words used to describe the relationship between elements should be interpreted in a similar manner (for example, “between” and “directly between”, “adjacent” and “directly adjacent”, etc.).

Wherever possible, the same reference numbers are used throughout the drawings to refer to the same or like parts. The terminology used herein is for the purpose of describing particular embodiments only and is not intended to limit embodiments of the present disclosure. As used herein, the singular forms “a”, “an”, and “the” are intended to include the plural forms as well, unless the context clearly indicates otherwise. It should be further understood that the terms “comprise”, “include”, and “have” and variations thereof used herein specify the presence of stated components, steps, operations, and/or elements and do not preclude the presence or addition of one or more other components, steps, operations, and/or elements. When a component, device, element, or the like of the present disclosure is described as having a purpose or performing an operation, function, or the like, the component, device, element, or the like should be considered herein as being “configured to” meet that purpose or to perform that operation or function. Each component, device, element, and the like may separately embody or be included with a processor and a memory, such as a non-transitory computer readable media, as part of the apparatus.

The present disclosure relates to a virtual gear shift control apparatus for an electric vehicle and a method thereof, capable of providing a user with a shift feel similar to that in power-off downshift of a high-performance internal combustion engine vehicle, according to vehicle driving conditions.

In particular, the present disclosure relates to a virtual gear shift control apparatus for an electric vehicle and a method thereof, capable of providing a user with a distinct virtual shift feel and a driving experience according to a gear stage and a virtual engine speed or a vehicle speed as vehicle driving conditions.

Because electric vehicles are not equipped with a multi-speed transmission, the shift feel that a driver can actually experience through a virtual gear shift function in an electric vehicle is a virtual shift feel that mimics a shift feel in an internal combustion engine vehicle.

The virtual gear shift function of the electric vehicle refers to a function of changing a longitudinal acceleration of the electric vehicle using torque variability of a motor, associating the result with a gear shifting event, and allowing the driver of the electric vehicle to feel as if the driver is driving a vehicle equipped with a virtual transmission.

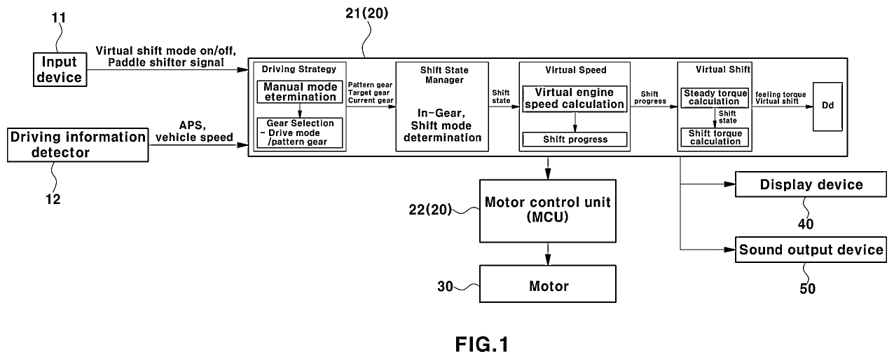

FIG. 1 is a block diagram showing a configuration of an apparatus that performs a virtual gear shift control process according to an embodiment of the present disclosure. FIG. 1 shows a main configuration for virtual gear shift control including a controller 20 of a virtual gear shift system.

As shown in FIG. 1, the virtual gear shift system includes a driving information detector 12 that detects vehicle driving information and includes the controller 20 that performs virtual gear shift control. The controller 20 includes a vehicle control unit (VCU) 21 that determines motor torque during virtual gear shift control and generates and outputs a motor torque command. The controller 20 includes a motor control unit (MCU) 22 that controls a motor 30, which is a drive unit of the vehicle, to output torque corresponding to the motor torque command output from the vehicle control unit 21.

The driving information detector 12 is a component that detects vehicle driving information necessary to determine a driver's demand torque and perform virtual gear shift control. The vehicle driving information, such as a driver's driving input value, input to the vehicle control unit 21 may include sensor detection information that is detected by the driving information detector 12 and is input to the vehicle control unit 21 through a vehicle network.

In the present embodiment, the driving information detector 12 may include an accelerator position sensor (APS) that detects a driver's accelerator position sensor value (APS value, %), a sensor that detects a drive system speed, and a sensor that detects a vehicle speed.

Here, the drive system speed may be a rotational speed of the motor 30, which is a drive unit that drives the vehicle, or a rotational speed (wheel speed) of driving wheels connected to the motor 30 for power transmission. Here, the sensor that detects the drive system speed may be a sensor that detects the rotational speed of the motor 30 and may be a typical resolver that detects a rotor position of the motor 30. Alternatively, the sensor that detects the drive system speed may be a typical wheel speed sensor that detects a rotational speed (wheel speed) of the driving wheels.

Further, the sensor that senses the vehicle speed may also be the wheel speed sensor. Because a technique of obtaining vehicle speed information from a signal from the wheel speed sensor is well-known in the relevant technical field, a detailed description thereof has been omitted.

As the vehicle driving information for determining and generating the driver's demand torque and the motor torque command in the vehicle control unit 21, the driver's accelerator position sensor value (APS value, %), the rotational speed of the motor 30, the rotational speed of the driving wheels, the vehicle speed, or the like, detected by the driving information detector 12, may be selectively used.

The vehicle control unit (VCU) 21 determines the driver's demand torque on the basis of the vehicle driving information detected by the driving information detector 12 and generates and outputs the motor torque command on the basis of the driver's demand torque. Because a technique of determining the driver's demand torque in the vehicle based on the vehicle driving information and determining the motor torque command based on the driver's demand torque is well-known in the technical field, a detailed description thereof has been omitted.

The motor control unit 22 receives the motor torque command output from the vehicle control unit 21 and controls an operation of the motor 30 through an inverter according to the motor torque command. As a result, the torque output from the motor 30 is applied to the driving wheels through a gear reducer and a differential of the drive system.

FIG. 1 shows an example in which the vehicle control unit 21 and the motor control unit 22 are provided as separate control subjects. However, the present disclosure is not limited thereto, and a configuration in which a single integrated control element is provided, instead of a plurality of controllers, may be used.

A single control element integrated with a plurality of controllers may be referred to as a controller, and the virtual gear shift control process according to the present disclosure to be described below may be performed by the controller. Unless specifically distinctly specified as the vehicle control unit and the motor control unit, hereinafter, the controller refers to an integrated control element that performs the virtual gear shift control process according to the present disclosure.

In addition, the shift control system according to the present disclosure may further include an input device 11 that a driver uses to perform operations or inputs necessary for operating the virtual gear shift system. The shift control system may further include a display device 40 that displays a variety of visual information when the virtual gear shift system operates. The shift control system may further include a sound output device 50 that outputs various virtual sounds when the virtual gear shift system operates.

The input device 11, the display device 40, and the sound output device 50 are connected to the controller 20 to perform on/off operations of a virtual shift mode, provide various UIs (User Interfaces), and output virtual sound.

Here, the input device 11 is used to input, select, and set a variety of information related to driver's manipulation, vehicle driving and virtual gear shifting necessary for operation of the virtual gear shift system, instead of driver's vehicle driving inputs such as an acceleration input, a braking input, and a steering input. The input device 11 may include an input device for the on/off operations of the virtual shift mode and a paddle shifter for a manual shift operation.

Further, the display device 40 is provided to display a variety of information and may include a cluster that displays a virtual gear stage (virtual shift stage) at the on operation of the virtual shift mode, i.e., in a state in which the virtual engine speed (RPM) and the virtual gear shift system are activated.

In addition, the input device 11 and the display device 40 may include operating devices, such as buttons or switches provided in the vehicle, input devices, and display devices of an AVN (Audio, Video, Navigation) system.

The sound output device 50 may be an audio device that includes an amplifier mounted in the vehicle and internal and external speakers of the vehicle to generate and output virtual sounds when the virtual shift mode is turned on, such as a virtual engine sound.

In the present embodiment, the input device 11, the display device 40, and the sound output device 50 may employ known devices that can input, select, or display a variety of information related to the on/off operations of the virtual shift mode, vehicle driving, and virtual shift and can generate and output virtual engine sounds.

In the present embodiment, the virtual gear shift system can generate torque and a virtual shift feel corresponding to each virtual gear stage through motor torque. The virtual gear shift system can also output a virtual engine speed, a virtual gear stage (a current gear stage or a target gear stage), a shift LED indicator, or the like through the cluster, which is the display device 40 to provide a maximized visual effect to a driver (cluster cooperative control performed by the vehicle control unit and a cluster control unit). The virtual gear shift system can also output a virtual engine sound through internal and external speakers of the vehicle in the sound output device 50 to provide an auditory effect to the driver (sound cooperative control performed by the vehicle control unit and a sound control unit).

In an internal combustion engine vehicle, as the engine speed (RPM) increases, friction and pumping loss inside an engine cylinder increase exponentially. In consideration of this phenomenon, in the virtual gear shift system of the electric vehicle according to the present embodiment, a coasting (power-off) torque that changes according to a rotational speed of a virtual engine (i.e., virtual engine speed, RPM) is implemented.

Thus, it is possible to implement a coasting torque for representing a realistic state in which the vehicle speed decreases more and more slowly as the vehicle coasts to a low RPM range. It is also possible to determine target torques before and after shifting at the time of shifting under power-off (i.e., coasting) conditions based on the coasting torque. The coasting torque, which varies exponentially under the power-off conditions, is used not only as a coasting torque in an in-gear state but also as torques before and after shifting under the power-off conditions.

In many high-performance vehicles equipped with internal combustion engines, a rev-matching downshift method of releasing a clutch to put a transmission into a neutral gear state for fast shifting at the time of power-off downshifting, quickly operating an engine from an unloaded state at a synchronous speed (RPM) of a target gear stage, and then engaging the clutch has been used.

Because physical connection with the engine is temporarily disconnected in the neutral gear state during shifting in the rev-matching, deceleration due to engine load is reduced to be close to zero. In this regard, in general virtual gear shift systems, at the time of power-off downshifting, because only the motor torque simply transitions from a starting output torque before shifting to a target torque after shifting, there is no section where the above-mentioned neutral feel can be provided during shifting.

According to the present embodiment, it is possible to implement a vehicle speed that changes exponentially in an in-gear coasting state, to use a coasting torque as a starting torque and a target torque for power-off downshifting, and to virtually implement a neutral feel provided according to the engine rev-matching during the power-off downshifting of the internal combustion engine vehicle. Thus, it is possible to provide a realistic driving experience more similar to a high-performance vehicle equipped with an actual internal combustion engine compared with the general techniques.

To this end, the virtual gear shift control method according to the present embodiment includes a method of implementing variable coasting deceleration under power-off conditions and includes a method of generating a rev-matching downshift feel under the power-off conditions.

First, in the present embodiment, non-linear coasting deceleration is implemented under vehicle power-off (coasting) conditions, and the coasting deceleration is differentiated according to gear stages and virtual engine speeds.

To this end, an engine load is calculated for each virtual engine speed, and a map is configured so that an engine torque due to the engine load (engine load torque) is set to a value corresponding to the virtual engine speed (RPM) so as to determine the engine load that changes exponentially in an in-gear coasting state. Using this map, it is possible to determine the engine torque as a function of the virtual engine speed.

Table 1 shows setting data used to determine the engine torque as the function of the virtual engine speed, in which a relationship between the virtual engine speed and the engine torque is defined. The setting data is configured as the map in which the engine torque is set to the value corresponding to the virtual engine speed.

TABLE 1

| | Virtual engine speed (RPM) | | | | | | | | |
|---|---|---|---|---|---|---|---|---|---|
| | 0 rpm | 1000 rpm | 2000 rpm | 3000 rpm | 4000 rpm | 5000 rpm | 6000 rpm | — rpm | Max. rpm |
| Engine | — Nm | — Nm | — Nm | — Nm | — Nm | — Nm | — Nm | — Nm | — Nm |
| load | | | | | | | | | |
| torque | | | | | | | | | |

Further, the relationship between the engine torque and the virtual engine speed may be expressed as Equation 1, and the engine torque corresponding to the virtual engine speed may be determined using Equation 1.

$${T}_{e} = {T}_{c} + {J}_{e} \times \frac{d {N}_{e}}{d r} \qquad [ Equation 1 ]$$

Here, Tₑ represents an engine torque, T_{c} represents a clutch torque, Jₑ represents an engine moving system inertia, Nₑ represents an engine speed (virtual engine speed), and dNₑ/dt represents an engine angular acceleration.

In addition, in order to express a friction force change in an actual engine, a map is configured in which the engine torque (engine friction torque) is set to a value corresponding to the virtual engine speed. Using this map, the engine torque (engine friction torque) may be determined as a function of the virtual engine speed as defined in Equation 2.

Equation 2 is an equation for defining (setting and determining) the engine torque as the function of the virtual engine speed. The map in which the engine torque is set to the value corresponding to the virtual engine speed, configured as shown in Equation 2, may be input to and stored in the controller 20.

$${TQ}_{Engine \_ Friction} = f ( {ω}_{Engine} ) \qquad [ Equation 2 ]$$

Here, TQ_{Engine_Friction} represents an engine friction torque as an engine torque, and ω_{Engine} represents an engine speed (virtual engine speed in the present embodiment).

In addition, a final coasting wheel torque (for example, wheel torque in coasting, hereinafter, referred to as a “coasting torque”) may be determined by multiplying the engine friction torque (TQ_{Engine_Friction}) determined as described above by a gear ratio of a current gear stage and a final reduction gear ratio. In the present embodiment, the gear ratio for each gear stage and the final reduction gear ratio are input to the controller 20 as preset values.

This may be expressed as Equation 3.

$${TQ}_{c oasting} = - 1 \times {TQ}_{Engine \_ Friction} \times {GearRatio}_{n} \times FGR \qquad [ Equation 3 ]$$

Here, TQ_{coasting} represents a coasting torque, GearRatoₙ represents a gear ratio of a current gear stage (n), and FGR represents a final reduction gear ratio.

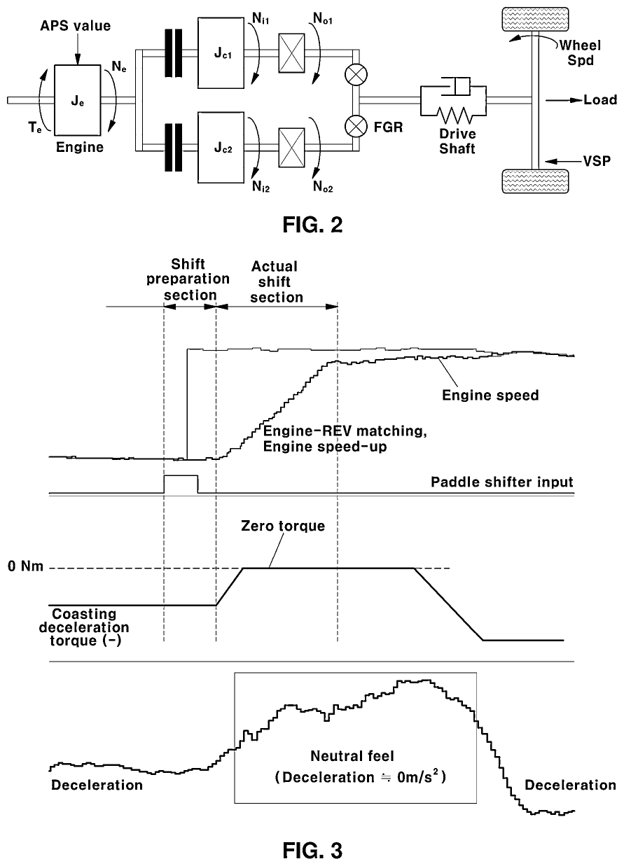

The above-mentioned Equation 1 may be derived through modeling of a drive system of an internal combustion engine vehicle. FIG. 2 is a diagram showing a drive system model of an internal combustion engine vehicle for deriving Equation 1, and FIG. 3 is a diagram illustrating a neutral feel in a REV-matching section of an internal combustion engine vehicle.

In FIG. 2, the APS value represents an accelerator position sensor value (for example, accelerator opening degree) detected by the accelerator position sensor of the driving information detector 12, Tₑ represents an engine torque, Jₑ represents an engine moving system inertia, and Nₑ represents an engine speed.

Further, in FIG. 2, J_{C1} represents an odd-numbered clutch inertia, J_{C2} represents an even-numbered clutch inertia, Nᵢ₁ represents an odd-numbered clutch input speed, and Nᵢ₂ represents an even-numbered clutch input speed. In addition, Nₒ₁ represents an odd-numbered clutch output speed, and Nₒ₂ represents an even-numbered clutch output speed. In FIG. 2, FGR represents a final reduction gear ratio, Wheel Spd represents a wheel speed, and VSP represents a vehicle speed.

As described above, in the internal combustion engine vehicle, in order to achieve fast shifting when power-off downshifting, the engine's rev-matching cooperative control is performed after the clutch is released to quickly increase the engine speed. In particular, an automatic transmission vehicle equipped with a DCT (Double Clutch Transmission) provides fast shifting through the rev-matching cooperative control.

In the case of a vehicle equipped with an actual transmission, when a clutch that is in an engaged state is released for the rev-matching control, the engine load on the vehicle's drive system is reduced, and the deceleration is reduced as in a neutral gear stage until the gear clutch is engaged at the end of the gear shift.

In the virtual gear shift control for general power-off downshifting performed in an electric vehicle, the motor torque is simply linearly increased or decreased from the coasting torque of the virtual gear stage before shifting to the coasting torque corresponding to the virtual gear stage (target gear stage) after shifting.

On the other hand, in the present embodiment, in order to provide a user with a distinct shift feel, a sporty and fast shift feel, a coasting deceleration close to zero in the neutral gear state from the engine rev-matching section is implemented to provide a more realistic shift feel.

As shown in FIG. 3, the coasting torque is a deceleration torque, which may be defined as a negative (−) value. Referring to FIG. 3, it can be seen that the rev-matching cooperative control is performed in the process of moving from the coasting torque in the virtual gear stage before shifting to the coasting torque in the virtual gear stage (target gear stage) after shifting.

While the engine speed is increasing in the rev-matching section, the coasting torque is controlled to zero corresponding to the neutral gear state. In this way, as the coasting torque is controlled to 0 Nm (zero torque), it is possible to provide a neutral feel indicating a coasting deceleration close to zero (≅0 m/s²).

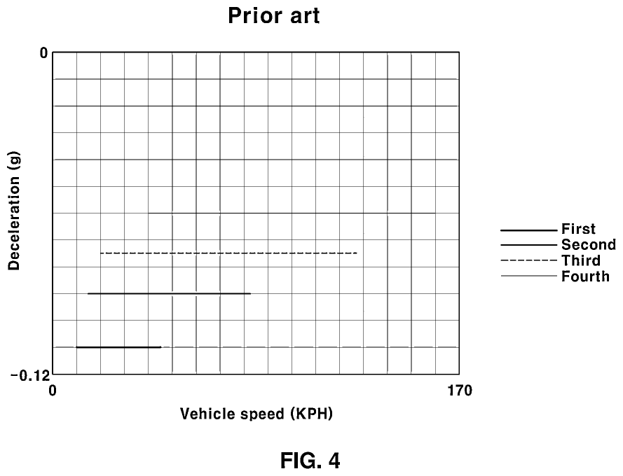

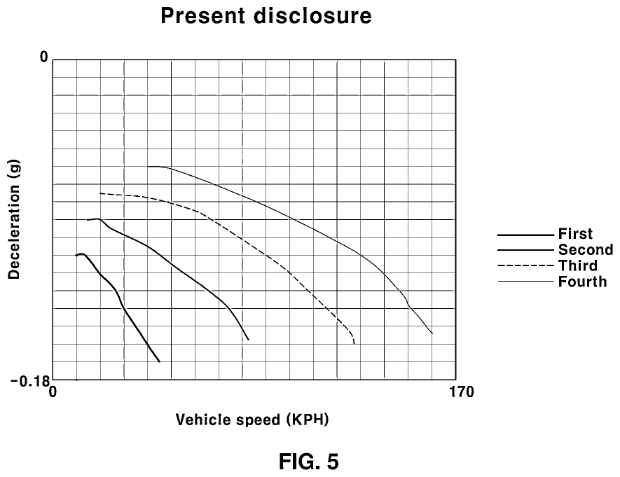

FIGS. 4 and 5 are diagrams for comparing virtual gear shift controls according to the prior art and the present embodiment, showing a comparison of vehicle deceleration states according to gear stages and vehicle speeds during power-off downshifting.

According to Equation 2, it can be understood that the engine torque (engine friction torque) may be determined as the value corresponding to the virtual engine speed, and in this case, the engine torque is determined as the value corresponding to the virtual engine speed through the map, or the like.

In determining the engine torque in this way, the engine torque (engine friction torque) may be determined from the map using a current virtual engine speed as an input variable, and then, a real-time coasting torque may be determined from a current engine torque and a current gear stage according to Equation 3.

Accordingly, it is possible to obtain the coasting torque as a value corresponding to the current gear stage and the virtual engine speed. As described above, the coasting torque may be determined as the value corresponding to the gear stage and the virtual engine speed, but instead, the coasting torque may be determined as a value corresponding to the gear stage and the vehicle speed.

As shown in FIG. 4, in the general virtual gear shift system, because a constant coasting torque is set for each gear stage, after a gear stage is determined, a constant coasting torque corresponding to that gear stage is determined, and a motor torque command for controlling the motor torque to the constant coasting torque is generated. Accordingly, the vehicle coasts with a constant coasting torque and a constant deceleration determined for each gear, regardless of the vehicle speed.

On the other hand, according to the virtual gear shift control method according to the present embodiment, as shown in FIG. 5, the vehicle performs a realistic coasting drive in which the deceleration changes depending on the vehicle speed even if the vehicle is in the same gear stage.

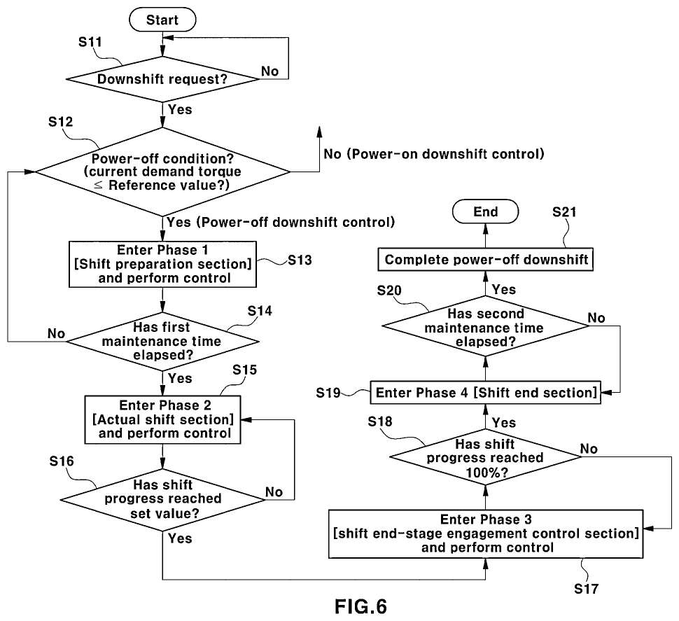

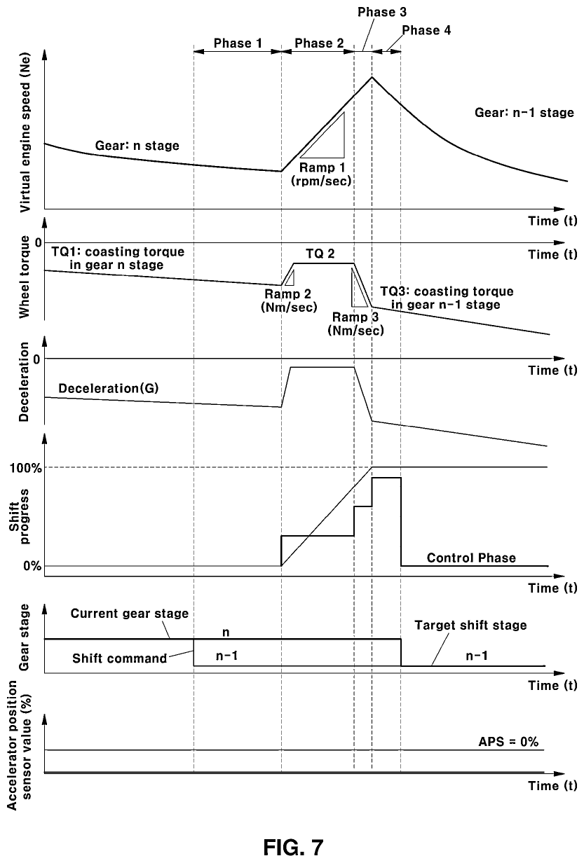

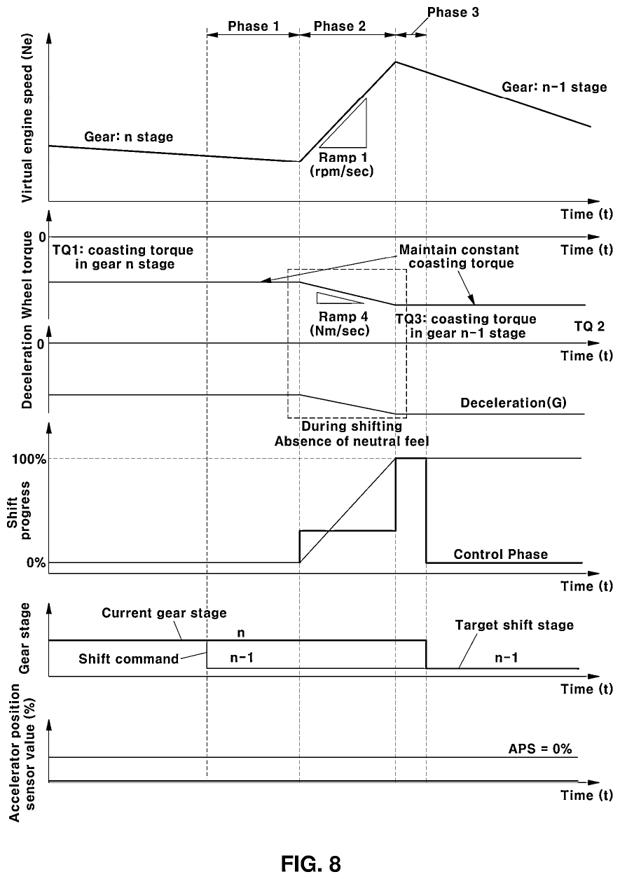

FIG. 6 is a flowchart showing a virtual gear shift control process according to the embodiment of the present disclosure. FIG. 7 is a diagram showing a control state by a virtual gear shift control method according to an embodiment of the present disclosure. FIG. 8 is a diagram showing a control state by a conventional virtual gear shift control method for comparison with the present disclosure.

In FIG. 6, a wheel torque (Nm) represents a torque applied to the driving wheels by the motor 30 that drives the vehicle, an n stage represents a virtual gear stage (current gear stage) before shifting, and an n-1 stage represents a virtual gear stage (target gear stage) after shifting. In the following description, gear shift means virtual gear shift, and a gear stage means a virtual gear stage determined in a virtual gear shift control process.

In addition, the torque during the virtual gear shift illustrated in FIGS. 6 and 7, i.e., the power-off downshift, is a regenerative torque with a negative (−) value, which is a regenerative torque applied to the driving wheels by the motor 30.

Further, in FIG. 6, an engine speed Nₑ represents a virtual engine speed. In the present embodiment, the virtual engine speed may be cluster display information calculated in real time and displayed on the cluster.

In the controller 20, the virtual engine speed may be determined as a value proportional to a value obtained by multiplying the current vehicle drive system speed by the virtual gear ratio value corresponding to the virtual gear stage or may be determined as a value proportional to a value obtained by multiplying the current vehicle speed by the virtual gear ratio value corresponding to the virtual gear stage.

Because the virtual engine speed in the present embodiment is not different from a virtual engine speed determined, displayed, and used in a typical virtual gear shift system, a detailed description of a method of determining the virtual engine speed described above has been omitted in the present disclosure.

The virtual gear shift control process according to the present embodiment, specifically, the power-off downshift control process includes a shift preparation section (Phase 1), an actual shift section (Phase 2), a shift end-stage engagement control section (Phase 3), and a shift end section (Phase 4).

In the present embodiment, the controller 20 determines whether there is a downshift request according to a vehicle driving state (S11) and determines, in a case where it is determined that there is the downshift request (Yes in S11), whether a current vehicle driving state corresponds to a predetermined power-off condition (S12). Here, in a case where it is determined that the current vehicle state does not correspond to the power-off condition (No in S12), the controller 20 performs power-on downshift control.

On the other hand, in a case where it is determined that the current vehicle state corresponds to the power-off condition (Yes in S12), the controller 20 generates a shift command for the power-off downshift and starts a power-off downshift control process to enter the shift preparation section (Phase 1) (S13). Here, the power-off condition may include such a condition that a driver's current demand torque is equal to or less than a preset reference value, in the controller 20.

When entering the shift preparation section (Phase 1) after the shift command is generated, the controller 20 determines whether the controller 20 maintains a coasting torque corresponding to a virtual gear stage before shifting for a predetermined first maintenance time (S14).

Here, as described above, the controller 20 determines the coasting torque corresponding to the virtual gear stage before shifting (“n stage” in FIG. 7) and a real-time virtual engine speed (or current vehicle speed) (coasting torque=f (current gear stage, current virtual engine speed)). The controller 20 also generates and outputs a motor torque command (regenerative torque command) to control the motor torque to the determined coasting torque.

Accordingly, a regenerative operation of the motor 30 is controlled according to the motor torque command, and the motor torque is maintained at a coasting torque determined as a value corresponding to the current gear stage and the current virtual engine speed during the shift preparation section.

Then, the controller 20 enters the actual shift section (Phase 2) (S15) after lapse of the first maintenance time set after entering the shift preparation section (Yes in S14). In the actual shift section, virtual engine speed control and torque control are performed, and engine rev-matching control is performed in the virtual engine speed control and the torque control process.

When entering the actual shift section (Phase 2), the controller 20 increases the virtual engine speed at the time of entry to an engine rev-matching control slope (Ramp 1, RPM/sec) for the engine rev-matching control. In other words, the engine rev-matching control is performed to increase the virtual engine speed from a synchronous speed (RPM) of the current gear stage (virtual gear stage before shifting) to a synchronous speed (RPM) of the virtual gear stage (target gear stage) after shifting. Here, the engine rev-matching control slope set in the controller 20 is used as an upward slope of the virtual engine speed.

In addition, in the virtual engine speed control process, the controller 20 performs cluster cooperative control so that the virtual engine speed that changes for the virtual engine rev-matching and the target gear stage is displayed on the cluster in real time. At the same time, the controller 20 performs sound cooperative control so that a virtual engine sound associated with the virtual engine speed is output through the sound output device 50.

The virtual engine speed control for increasing the virtual engine speed to the synchronous speed of the virtual gear stage after shifting with the engine rev-matching control slope (Ramp 1), i.e., the above-mentioned engine rev-matching control is performed in the actual shift section (Phase 2) and the shift end-stage engagement control section which is a subsequent process.

More specifically, in performing the engine rev-matching control by the controller 20, the virtual engine speed may be increased by a set ratio (for example, 80%) of a difference between the synchronous speed of the virtual gear stage before shifting and the synchronous speed of the virtual gear stage after shifting in the actual shift section (Phase 2). The virtual engine speed may be increased by the remaining ratio (for example, 20%) in the shift end-stage engagement control section.

More specifically, assuming that the virtual engine speed at the time of entering the actual shift section is defined as a first speed (synchronous speed before shifting), the controller 20 increases the virtual engine speed to a second speed with the engine rev-matching control slope in the actual shift section. The controller 20 also increases the virtual engine speed to a third speed that is the synchronous speed after shifting with the engine rev-matching control slope in the shift end-stage engagement control section.

Here, the first speed is the virtual engine speed in the current vehicle speed and the current gear stage (virtual gear stage before shifting) at the time of entering the actual shift section. The third speed is the virtual engine speed in the current vehicle speed and the target gear stage (virtual gear stage after shifting). The second speed is a speed increased from the first speed by the set ratio (%) of the difference between the third speed and the first speed.

The current virtual engine speed, which is the real-time speed that increases in the actual shift section (Phase 2), may be determined as a speed obtained by adding a value to the first speed. The value is obtained by multiplying the elapsed time after entering the actual shift section by the rev-matching control slope (Ramp 1).

This may be defined as the expression of ‘current virtual engine speed (RPM)=first speed (RPM)+elapsed time after entering actual shift section (sec)×engine rev-matching control slope (RPM/sec)’.

In addition, after entering the actual shift section (Phase 2), the controller 20 changes a coasting torque (TQ1) at the time of entering the actual shift section to a preset neutral torque (TQ2) with a first torque slope (Ramp 2, Nm/sec) (change from TQ1 to TQ2).

Here, the coasting torque is a regenerative torque determined as a negative (−) value. Further, the coasting torque (TQ1) at the time of entering the actual shift section is determined as a value corresponding to the current gear stage and the virtual engine speed (or vehicle speed) at the time of entry.

In this way, after the coasting torque that changes with the determined first torque slope up to the neutral torque (TQ2) is determined, the controller 20 may generate a motor torque command in real time based on the changing coasting torque and may control the regenerative operation of the motor 30 in real time according to the generated motor torque command. Accordingly, the wheel torque applied to the driving wheels by the motor 30 may be controlled using the changing coasting torque.

In addition, after entering the actual shift section (Phase 2) and changing the coasting torque up to the neutral torque (TQ2), the controller 20 maintains the coasting torque at the neutral torque (TQ2) until entering the shift end-stage engagement control section (Phase 3).

The neutral torque (TQ2) represents a torque value set to virtually implement, in an electric vehicle (to which the present embodiment is applied), a coasting torque in a neutral gear state in which a transmission clutch is released in an internal combustion engine vehicle equipped with a transmission. The neutral torque (TQ2) may be set to a regenerative torque value (negative (−) torque value) close to zero, as shown in FIG. 7.

Further, in the actual shift section (Phase 2), the controller 20 may compare the current virtual engine speed with the first speed and the third speed to determine shift progress (%) and may perform cluster cooperative control so that the determined shift progress can be displayed through the cluster in real time. The shift progress may be calculated as shown in Equation 4.

$$Shift progress ( \% ) = \{ ( current virtual engine speed - first speed ) / ( third speed - first speed ) \} \times 100 \qquad [ Equation 4 ]$$

In addition, the controller 20 determines whether the shift progress (%) reaches a set value (for example, 80%) during the actual shift section (Phase 2) (S16). The controller 20 enters, in a case where the shift progress reaches the set value (Yes in S16), the shift end-stage engagement control section (Phase 3) after the actual shift section ends (S17).

In the shift end-stage engagement control section (Phase 3), the virtual engine speed control is maintained to increase the virtual engine speed to the synchronous speed of the virtual gear stage after shifting with the engine rev-matching control slope (Ramp1). In other words, at the time of entering the shift end-stage engagement control section, the virtual engine speed is increased from the second speed to the third speed with the engine rev-matching control slope (Ramp 1).

The real-time virtual engine speed that changes during the shift end-stage engagement control section (Phase 3) may be determined as the expression of ‘current virtual engine speed (RPM)=first speed (RPM)+elapsed time after entering the actual shift section (sec)×engine rev-matching control slope (RPM/sec)’ as in the actual shift section.

Further, in the shift end-stage engagement control section (Phase 3), the shift progress (%) may be calculated in the same way, the virtual engine speed that continues to change in real time during the power-off downshift control process under the control of the controller 20 is displayed through the cluster, and the shift progress (%) obtained in real time in the actual shift section and the shift end-stage engagement control section may be displayed through the cluster.

In addition, the controller 20 decreases the coasting torque from the neutral torque (TQ2) with a predetermined second torque slope at the time of entering the shift end-stage engagement control section (Phase 3) and then determines whether the shift progress has reached 100% (S18). In a case where it is determined that the shift progress reaches 100% (Yes in S18), the controller 20 terminates the shift end-stage engagement control section (Phase 3) and enters the shift end section (Phase 4) (S19).

The virtual engine speed at the point of transition from the shift end-stage engagement control section (Phase 3) to the shift end section (Phase 4) becomes the third speed. Here, in a case where the virtual engine speed increases according to the engine rev-matching control slope to reach the third speed, the shift progress becomes 100% according to Equation 4. In this way, at the end of the shift end-stage engagement control section (Phase 3) and at the entry point of the shift end section (Phase 4), the virtual engine speed becomes the third speed, and the shift progress becomes 100%.

Further, a coasting torque (TQ3) at the point of transition from the shift end-stage engagement control section (Phase 3) to the shift end section (Phase 4) is a torque changed from the neutral torque (TQ1) with the second torque slope until the shift progress reaches 100% (changed from TQ2 to TQ3). The coasting torque (TQ3) is a torque determined as a value corresponding to the target gear stage (virtual gear stage after shifting) and the virtual engine speed (or vehicle speed).

After entering the shift end section (Phase 4) as described above, the coasting torque (wheel torque) is determined as a value corresponding to the virtual gear stage after shifting and the current virtual engine speed (or current vehicle speed), by the controller 20. In addition, the controller 20 determines whether a set second maintenance time has elapsed (S20) and terminates the shift end section (Phase 4) after the second maintenance time has elapsed (Yes in S20). Thus, the entire power-off downshift control process is completed (S21).

After entering the shift end section (Phase 4), the coasting torque is determined as a value corresponding to the target gear stage (virtual gear stage after shifting) and the current virtual engine speed (or current vehicle speed). In a case where the power-off condition is maintained even after the power-off downshift is completed, the coasting torque is determined as a value corresponding to the target gear stage (virtual gear stage after shifting) and the current virtual engine speed (or current vehicle speed).

As described above, according to the virtual gear shift control apparatus and method according to the present disclosure, it is possible to virtually implement and provide a neutral coasting torque and a neutral feel during shifting according to release of a transmission clutch in engine-rev matching of an internal combustion engine vehicle, in controlling a coasting torque during power-off downshifting.

As a result, it is possible to improve driver's perception of shifting by providing a distinct shift feel to a driver. Thus it is possible to provide a distinct shift feel, a sporty and fast shift feel that can be felt in a general sports car, a realistic shift feel, and a fun-to-drive experience.

In addition, according to the present disclosure, under the power-off condition of the virtual gear shift system, the coasting torque is continuously varied not only according to the gear stage but also according to the virtual engine speed (or vehicle speed) in consideration of the friction force and pumping loss inside the engine cylinder.

The coasting torque determined in this way may be used as the start and target torques for power-off downshifting in the electric vehicle's virtual gear shift system. Thus it is possible to provide a realistic driving experience similar to an actual internal combustion engine vehicle compared with a general virtual gear shift control method.

The technical concepts of the present disclosure have been described in detail with reference to embodiments thereof. However, it should be appreciated by those having ordinary skill in the art that changes may be made in these embodiments without departing from the principles and spirit of the present disclosure, the scope of which is defined in the appended claims and their equivalents.

Reference numerals set forth in the drawings include reference to the following elements as further discussed below:
11: Input device
12: Driving information detector
20: Controller
21: Vehicle control unit
22: Motor control unit
30: Motor
40: Display device
50: Sound output device

What is claimed is:

1. A method of controlling virtual gear shift for an electric vehicle, the method comprising:
determining, by a controller, whether a vehicle driving state of the electric vehicle corresponds to a predetermined power-off condition;
determining, by the controller, in response to a determination that the vehicle driving state corresponds to the predetermined power-off condition, a coasting torque corresponding to a current virtual gear stage, and a current virtual engine speed;
generating, by the controller, a motor torque command using the determined coasting torque as a command value; and
controlling a regenerative operation of a motor configured to drive the electric vehicle according to the generated motor torque command.

2. The method according to claim 1, wherein determining the coasting torque comprises:
determining an engine friction torque corresponding to the current virtual engine speed using setting data with a virtual engine speed as an input; and
determining the coasting torque as a negative torque value obtained by multiplying the determined engine friction torque by a gear ratio of the current virtual gear stage and a final reduction gear ratio.

3. The method according to claim 1, further comprising:
determining, by the controller, whether there is a downshift request according to the vehicle driving state; and
performing, by the controller, a power-off downshift control process in response to a determination that there is the downshift request and the vehicle driving state corresponds to the predetermined power-off condition,
wherein performing the power-off downshift control process includes, in a process of transitioning from a coasting torque in a virtual gear stage before shifting to a coasting torque in a virtual gear stage after shifting, entering, by the controller, an actual shift section in which the coasting torque increases to a preset neutral torque and then is kept constant.

4. The method according to claim 3, wherein performing the power-off downshift control process further comprises:
entering, by the controller, a shift preparation section in which the coasting torque corresponding to the virtual gear stage before shifting and the current virtual engine speed that is a real-time speed is determined during a first maintenance time after the power-off downshift control process starts; and
entering, by the controller, the actual shift section after the shift preparation section ends during the first maintenance time.

5. The method according to claim 3, further comprising:
when entering the actual shift section, increasing, by the controller, a virtual engine speed at the time of entering the actual shift section with a slope for engine rev-matching control.

6. The method according to claim 3, wherein performing the power-off downshift control process further comprises:
entering, by the controller, a shift end-stage engagement control section that increases a virtual engine speed to a synchronous speed in the virtual gear stage after shifting, after the actual shift section ends; and
simultaneously decreasing, by the controller, the coasting torque from the preset neutral torque to the coasting torque corresponding to the virtual gear stage after shifting.

7. The method according to claim 6, further comprising:
during the actual shift section, determining, by the controller, a shift progress from the current virtual engine speed;
terminating, by the controller, in a case where the shift progress becomes a set value, the actual shift section; and
entering, by the controller, the shift end-stage engagement control section.

8. The method according to claim 7, further comprising:
determining, by the controller, the shift progress using an Equation E1:
$$Shift progress ( \% ) = \{ ( current virtual engine speed - first speed ) / ( third speed - first speed ) \} \times 100 ,$$
wherein the first speed is a virtual engine speed at the time of entering the actual shift section, the third speed is the synchronous speed of the virtual gear stage after shifting and is a virtual engine speed corresponding to a current vehicle speed and the virtual gear stage after shifting, and the current virtual engine speed is a real-time speed.

9. A virtual gear shift control apparatus for an electric vehicle, the apparatus comprising:
a driving information detector configured to detect information indicating a vehicle driving state; and
a controller configured to
generate a motor torque command for satisfying a driver's demand torque based on vehicle driving information including the information detected by the driving information detector,
determine whether the vehicle driving state of the electric vehicle corresponds to a predetermined power-off condition,
determine, in response to a determination that the vehicle driving state corresponds to the predetermined power-off condition, a coasting torque corresponding to a current virtual gear stage and a current virtual engine speed,
generate a motor torque command using the determined coasting torque as a command value, and
control a regenerative operation of a motor that drives the electric vehicle according to the generated motor torque command.

10. The apparatus according to claim 9, wherein the predetermined power-off condition is a condition that the driver's demand torque is equal to or less than a preset reference value.

11. The apparatus according to claim 9, wherein the controller is further configured to:
determine an engine friction torque corresponding to the current virtual engine speed using setting data with a virtual engine speed as an input; and
determine the coasting torque as a negative torque value obtained by multiplying the determined engine friction torque by a gear ratio of the current virtual gear stage and a final reduction gear ratio.

12. The apparatus according to claim 11, wherein the setting data is a function or a map that defines a relationship between the virtual engine speed and the engine friction torque.

13. The apparatus according to claim 9, wherein the controller is further configured to:
determine whether there is a downshift request according to the vehicle driving state;
perform a power-off downshift control process, in response to a determination that there is the downshift request and the vehicle driving state corresponds to the predetermined power-off condition; and
when performing the power-off downshift control process, entering, in a process of transitioning from a coasting torque in a virtual gear stage before shifting to a coasting torque in a virtual gear stage after shifting, an actual shift section in which the coasting torque increases to a preset neutral torque and then is kept constant.

14. The apparatus according to claim 13, wherein, when performing the power-off downshift control process, the controller is further configured to:
enter a shift preparation section in which the coasting torque corresponding to the virtual gear stage before shifting and the current virtual engine speed that is a real-time speed is determined during a first maintenance time after the power-off downshift control process starts; and
enter the actual shift section after the shift preparation section ends during the first maintenance time.

15. The apparatus according to claim 13, when entering the actual shift section, the controller is further configured to increase a virtual engine speed at the time of entering the actual shift section with a slope for engine rev-matching control.

16. The apparatus according to claim 13, wherein, when performing the power-off downshift control process, the controller is further configured to:
enter a shift end-stage engagement control section that increases a virtual engine speed to a synchronous speed in the virtual gear stage after shifting, after the actual shift section ends; and
simultaneously decrease the coasting torque from the preset neutral torque to the coasting torque corresponding to the virtual gear stage after shifting.

17. The apparatus according to claim 16, wherein, during the actual shift section, the controller is further configured to:
determine a shift progress from the current virtual engine speed;
terminate, in a case where the shift progress becomes a set value, the actual shift section; and
enter the shift end-stage engagement control section.

18. The apparatus according to claim 17, wherein the controller is further configured to:
determine the shift progress using an Equation E1:
$$s hift progress ( \% ) = \{ ( current virtual engine speed - first speed ) / ( third speed - first speed ) \} \times 100 ,$$
wherein the first speed is a virtual engine speed at the time of entering the actual shift section, the third speed is the synchronous speed of the virtual gear stage after shifting and is a virtual engine speed corresponding to a current vehicle speed and the virtual gear stage after shifting, and the current virtual engine speed is a real-time speed.

19. The apparatus according to claim 16, wherein, when performing the power-off downshift control process, the controller is further configured to perform a shift end section in which the coasting torque corresponding to the virtual gear stage after shifting and the current virtual engine speed that is a real-time speed is determined, during a second maintenance time after the shift end-stage engagement control section ends.

20. The apparatus according to claim 9, wherein the current virtual engine speed is determined as a value proportional to a value obtained by multiplying a current vehicle speed by a virtual gear ratio corresponding to a current virtual gear shift stage, by the controller.
